(19) United States
(12) Patent Application Publication
(10) Pub. No.: US 2021/0012304 A1
(43) Pub. Date: Jan. 14, 2021

(54) INFORMATION PROCESSING APPARATUS, INFORMATION PROCESSING METHOD, STORAGE MEDIUM OF PROGRAM, AND STORAGE MEDIUM OF MOBILE TERMINAL PROGRAM

(71) Applicant: NEC Corporation, Minato-ku, Tokyo (JP)

(72) Inventors: Sae OKAWARA, Tokyo (JP); Takahiro MATSUI, Tokyo (JP); Jun UCHIMURA, Tokyo (JP)

(73) Assignee: NEC Corporation, Minato-ku, Tokyo (JP)

(21) Appl. No.: 16/980,636

(22) PCT Filed: Mar. 14, 2019
(86) PCT No.: PCT/JP2019/010698

§ 371 Date: Sep. 14, 2020

(30) Foreign Application Priority Data
Mar. 19, 2018 (JP) 2018-051331

(51) Int. Cl. G06Q 20/20; G06Q 20/32; G07G 1/12; G07G 1/01

(52) U.S. Cl. CPC G06Q 20/20; G07G 1/01; G07G 1/12; G06Q 20/32

(57) ABSTRACT

An information processing apparatus according to one example embodiment of the present invention includes a shop terminal that performs a checkout process of a product or a service; a customer terminal that performs information display and operation input that are related to the checkout process; and a control unit that causes a mobile terminal possessed by a customer to perform the information display and the operation input.

### TECHNICAL FIELD

The present invention relates to an information processing apparatus, an information processing method, a storage medium of a program, and a storage medium of a mobile terminal program.

### BACKGROUND ART

Point Of Sales (POS) apparatuses have been introduced in shops such as supermarkets, convenience stores, or the like, and a technology for causing information displayed on a customer display of a POS apparatus to be displayed on an information terminal of a customer has been proposed. For example, Patent Literature 1 discloses a system in which transaction information on a customer is displayed on a mobile phone of the customer without displaying a customer display of a POS apparatus.

### CITATION LIST

### Patent Literature

PTL 1: Japanese Patent Application Laid-open No. 2009-277055

### SUMMARY OF INVENTION

### Technical Problem

In the system disclosed in Patent Literature 1, however, a customer has to operate a POS apparatus that the customer is not familiar with how to operate, and the burden on the customer will increase.

The present invention has been made in view of the above problem and intends to provide an information processing apparatus, an information processing method, a storage medium of a program, and a storage medium of a mobile terminal program that can reduce the burden on a customer.

According to one example aspect of the present invention, provided is an information processing apparatus including: a shop terminal that performs a checkout process of a product or a service; a customer terminal that performs information display and operation input that are related to the checkout process; and a control unit that causes a mobile terminal possessed by a customer to perform the information display and the operation input.

According to another example aspect of the present invention, provided is an information processing method in an information processing apparatus including a shop terminal that performs a checkout process of a product or a service and a customer terminal that performs information display and operation input that are related to the checkout process, and the information processing method includes a step of: causing a mobile terminal possessed by a customer to perform the information display and the operation input.

According to another example aspect of the present invention, provided is a storage medium storing a program that causes a computer to perform an information processing method in an information processing apparatus including a shop terminal that performs a checkout process of a product or a service and a customer terminal that performs information display and operation input that are related to the checkout process, and the program includes a step of: causing a mobile terminal possessed by a customer to perform the information display and the operation input.

According to another example aspect of the present invention, provided is a storage medium storing a mobile terminal program executed by a computer of a mobile terminal possessed by a customer, and the mobile terminal program includes a step of: based on a signal from an information processing apparatus including a shop terminal that performs a checkout process of a product or a service and a customer terminal that performs information display and operation input that are related to the checkout process, causing the mobile terminal to perform the information display and the operation input.

According to the present invention, it is possible to reduce the burden on a customer.

### BRIEF DESCRIPTION OF DRAWINGS

FIG. 1 is an external view of a POS apparatus according to a first example embodiment.

FIG. 2 is an overall configuration diagram of a POS system using the POS apparatus according to the first example embodiment.

FIG. 3 is a block diagram of the POS apparatus according to the first example embodiment.

FIG. 4 is a diagram illustrating an example of checkout information displayed on a mobile terminal according to the first example embodiment.

FIG. 5 is a flowchart illustrating an example of a process of membership registration and download of a mobile terminal program according to the first example embodiment.

FIG. 6 is a flowchart illustrating an example of a process using the mobile terminal according to the first example embodiment.

FIG. 7 is a flowchart illustrating an example of an authentication process according to the first example embodiment.

FIG. 8 is a flowchart illustrating an example of a product reading process according to the first example embodiment.

FIG. 9 is a time chart illustrating an example of a process using a plurality of mobile terminals according to a second example embodiment.

FIG. 10 is a flowchart illustrating an example of an electronic payment process using a mobile terminal according to a third example embodiment.

FIG. 11 is a general configuration diagram of an information processing apparatus according to a fourth example embodiment.

### DESCRIPTION OF EMBODIMENTS

### First Example Embodiment

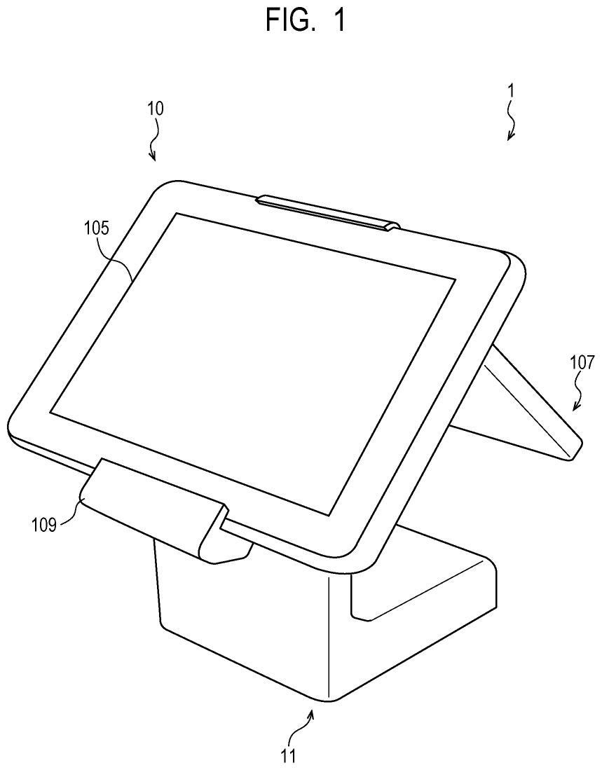

A first example embodiment of the present invention will be described with reference to FIG. 1 to FIG. 8.

FIG. 1 is an external view of a POS apparatus 1 (information processing apparatus) according to the present example embodiment. The POS apparatus 1 has a customer terminal 10 and a checkout terminal 11 (shop terminal) and is used in a shop such as a supermarket, a convenience store, or the like, for example. The customer terminal 10 has a first display device 105 and the like and displays information related to a checkout process (hereafter, referred to as checkout information) or the like on the first display device 105 to a customer. The checkout terminal 11 has a second display device 107, a holder part 109, and the like and performs a checkout process of a product to be purchased by a customer or the like. The second display device 107 displays checkout information or the like to a salesclerk. The holder part 109 supports the customer terminal 10. The customer terminal 10 may be detachable from the holder part 109. In such a case, the holder part 109 has a function as a cradle. Note that the checkout terminal 11 may also be configured to be detachable from the cradle.

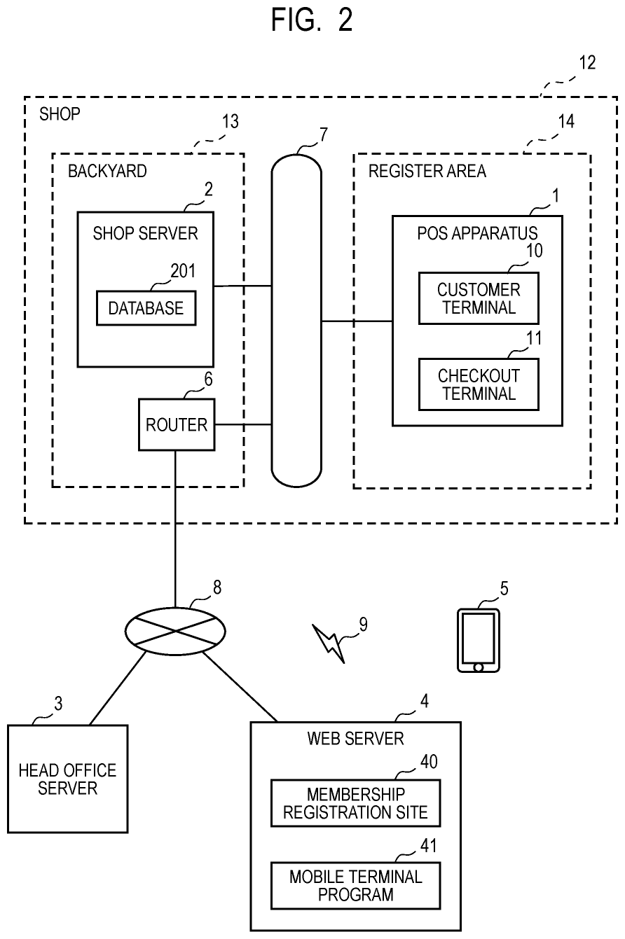

FIG. 2 is an overall configuration diagram of a POS system (point of sales information management system) using the POS apparatus 1 according to the present example embodiment. The POS system has the POS apparatus 1, a shop server 2, a head office server 3, a web server 4, and a mobile terminal 5. The POS apparatus 1 and the shop server 2 are communicably connected to each other via an intra-shop network 7. The POS apparatus 1 and the shop server 2 are connected to a network 8 such as the Internet via a router 6 connected to the intra-shop network 7. The head office server 3 and the web server 4 are communicably connected to the POS apparatus 1 and the shop server 2 via the network 8. The mobile terminal 5 is an information terminal possessed by a customer and is connected to the network 8 via a communication company network 9. Note that the numbers of the POS apparatuses 1 and shops 12 are not particularly limited, and a plurality of POS apparatuses 1 may be installed in one shop. Further, a plurality of shops 12 may be managed by the head office server 3 and the web server 4.

The POS apparatus 1 is installed in a register area 14 of the shop 12 and has the customer terminal 10 and the checkout terminal 11 as described above.

The customer terminal 10 has the first display device 105 and the like and displays checkout information or the like on the first display device 105 to a customer. The customer terminal 10 is a tablet terminal having a touch panel function, for example, and a customer performs operation input related to the age or the like, for example on the customer terminal 10 if necessary.

The checkout terminal 11 has the second display device 107 and the like and displays checkout information or the like on the second display device 107 to a salesclerk. The salesclerk performs operation input related to a checkout process on the checkout terminal 11 if necessary and performs a checkout process of a product to be purchased by a customer or the like.

The shop server 2 is installed in a backyard 13 of the shop 12 and manages information related to a product, a membership, a shop, stock, sales, or the like. The shop server 2 has a database 201 that stores a product table, a membership table, a shop table, a stock table, a membership purchase history table, a sales table, or the like.

The product table represents information related to products and stores product IDs that specify individual products, product names, prices, operation input flags, or the like. Note that, for example, the operation input flag “0” represents a product which does not require operation input, and the operation input flag “1” represents a product which requires operation input. The membership table represents information related to memberships and stores membership IDs that identify individual memberships, terminal IDs, names, dates of birth, addresses, telephone numbers, or the like. Note that the terminal ID is information that identifies the mobile terminal 5 possessed by a member. The shop table represents information related to shops and stores shop IDs that identify individual shops, shop names, addresses of shops, or the like. The stock table represents information related to stock and stores product IDs, shop IDs, stock quantities, or the like. The membership purchase history table represents products purchased by members in the past or the like and stores membership IDs, product IDs of purchased products, shop IDs of purchase shops, dates of purchase, purchase quantities, purchase amounts, or the like. The sales table represents information related to sales on a shop basis and stores dates of sales, shop IDs, product IDs, sales quantities, sales amounts, or the like. Note that the database 201 may be provided in the head office server 3 or the web server 4.

The head office server 3 is managed by a head office that supervises respective shops and, for example, aggregates and collectively manages sales data of respective shops as appropriate and calculates the stock quantities of respective shops based on the sales data. The calculated stock information on all the shops are transmitted to the shop server 2 of each shop as appropriate and stored in the stock table of the database 201.

The web server 4 stores a membership registration site 40, a mobile terminal program 41, or the like. The membership registration site 40 is a web site with which a customer registers a membership and is opened on the network 8. A customer uses the mobile terminal 5 to access the web server 4 via the communication company network 9, inputs personal information in a membership registration form, and downloads the mobile terminal program 41, or the like in the membership registration site 40. The mobile terminal program 41 is a program that can be started up on the mobile terminal 5 possessed by a customer and can be downloaded from the web server 4.

The mobile terminal 5 is an information terminal possessed by a customer and has a wireless communication function, a touch panel function, or the like. The mobile terminal 5 is an information terminal such as a smartphone, a tablet terminal, or the like, for example. The mobile terminal 5 in which the mobile terminal program 41 has been downloaded can transmit and receive data to and from the POS apparatus 1 by performing short-range wireless communication such as Bluetooth® or the like, wireless communication such as Wi-Fi® via wireless LAN connection, infrared wireless communication, or the like, for example. A customer may perform authentication by using the mobile terminal 5 and, if the authentication is successful, cause the mobile terminal 5 to perform information display and operation input related to a checkout process.

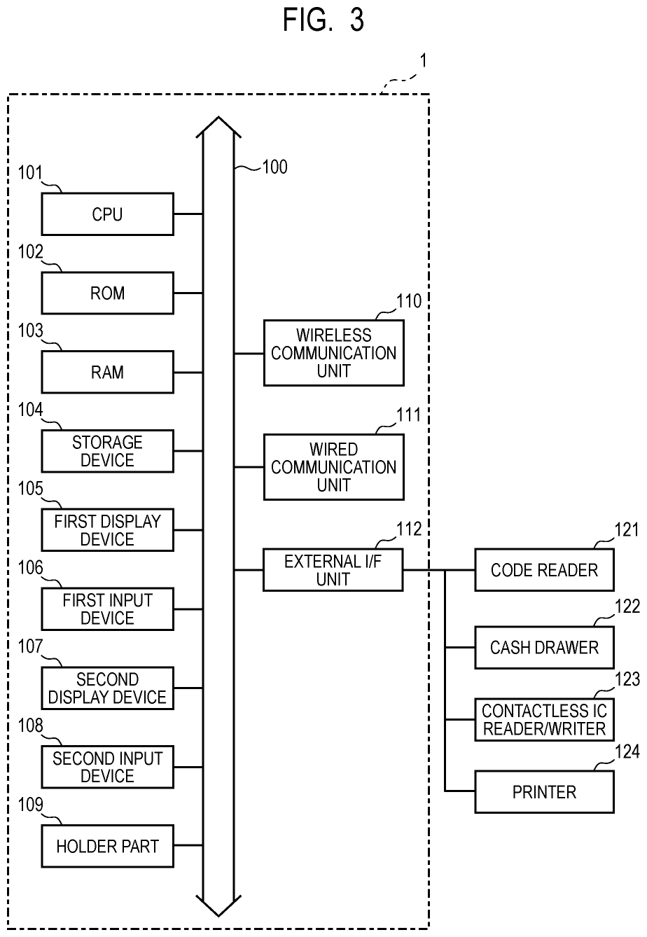

FIG. 3 is a block diagram of the POS apparatus 1 according to the present example embodiment. The POS apparatus 1 has a bus 100, a CPU 101, a read only memory (ROM) 102, a random access memory (RAM) 103, and a storage device 104. Further, the POS apparatus 1 has the first display device 105, a first input device 106, the second display device 107, a second input device 108, the holder part 109, a wireless communication unit 110, a wired communication unit 111, and an external interface (I/F) unit 112. These components are communicably connected to each other via the bus 100.

The CPU 101 controls each component of the POS apparatus 1 in accordance with an application program. The ROM 102 is formed of a nonvolatile memory and stores an application program used for controlling each component of the POS apparatus 1. The RAM 103 provides a memory area required for the operation of the CPU 101. The storage device 104 is a large-capacity storage device such as a hard disk.

The first display device 105 is a display device provided to the customer terminal 10 and is formed of a liquid crystal display, a light-emitting diode (LED) display, or the like, for example. The first display device 105 displays checkout information or the like to a customer. The first input device 106 is formed of a touch panel or the like, for example, and a customer performs operation input related to the age or the like, for example, via the first input device 106.

The second display device 107 is a display device provided to the checkout terminal 11 and is formed of a liquid crystal display, an LED display, or the like, for example. The second display device 107 displays checkout information or the like to a salesclerk. The second input device 108 is formed of a touch panel, a keyboard, a mouse, or the like, for example, and a salesclerk performs operation input related to a checkout process via the second input device 108. The holder part 109 has an interface with a customer terminal 10 configured to be detachable, for example. In such a case, the holder part 109 functions as a cradle including a serial communication circuit, a charging circuit, or the like, for example.

The wireless communication unit 110 is a communication unit that transmits and receives data by wireless communication and is configured to be able to perform short-range wireless communication such as Bluetooth or the like, wireless communication such as Wi-Fi via wireless LAN connection, infrared wireless communication, or the like, for example. The POS apparatus 1 can communicate with the shop server 2 and the mobile terminal 5 via the wireless communication unit 110. The wired communication unit 111 is an interface used for connecting the POS apparatus 1 to the intra-shop network 7 via a communication cable. That is, the POS apparatus 1 can communicate with the shop server 2 via the wireless communication unit 110 or the wired communication unit 111.

The external I/F unit 112 is an interface that connects the POS apparatus 1 to peripheral devices such as a code reader 121, a cash drawer 122, a contactless integrated circuit (IC) reader/writer 123, a printer 124, or the like, for example.

The code reader 121 reads a membership code displayed on the mobile terminal 5, a product code attached to a product, or the like, for example, in accordance with the control by the CPU 101. Note that the membership code or the product code may be a one-dimensional barcode or may be a two-dimensional code such as a QR code (registered trademark).

The cash drawer 122 stores coins, bills, or the like for cash payment and is opened in accordance with the control by the CPU 101. The contactless IC reader/writer 123 acquires credit card information, electronic money information, or the like for payment from the mobile terminal 5 or a contactless IC chip of a medium such as a card, for example, in accordance with the control by the CPU 101. The printer 124 prints and outputs a receipt or the like in accordance with the control by the CPU 101.

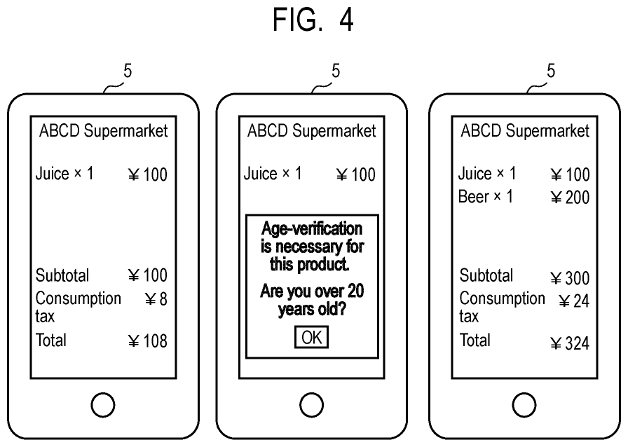

FIG. 4 is a diagram illustrating an example of checkout information displayed on the mobile terminal 5 according to the present example embodiment. In FIG. 4, a case where a customer purchases a juice and a beer is assumed, for example.

The left screen of FIG. 4 represents checkout information displayed on the mobile terminal 5 when a salesclerk has caused the product code of a juice to be read as the first item. Once the salesclerk causes the code reader 121 to read the product code of the juice, the product name, the quantity, the amount, and the like are displayed on the mobile terminal 5. The center screen of FIG. 4 represents checkout information displayed on the mobile terminal 5 when the salesclerk has caused the product code of a beer to be read as the second item. Once the salesclerk causes the code reader 121 to read the product code of the beer, a message to the effect that age-verification is required is displayed on the mobile terminal 5. In response to the customer pressing the OK button of the age-verification message, checkout information related to the beer is displayed on the mobile terminal 5 as illustrated in the right screen of FIG. 4. Note that display of an age-verification message may be omitted by automatically determining whether or not the customer has reached adulthood based on membership registration information on the customer.

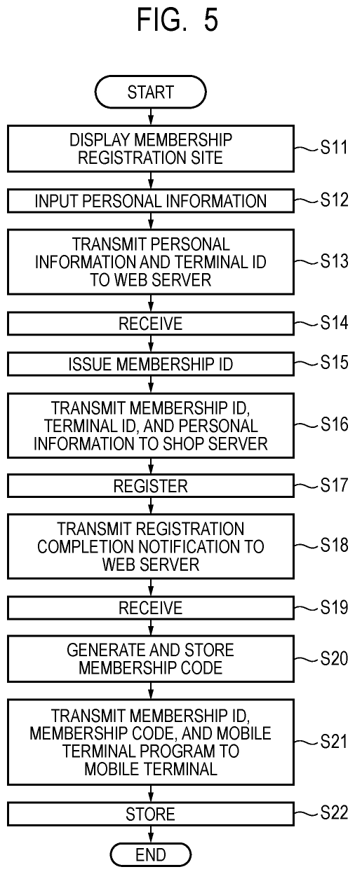

FIG. 5 is a flowchart illustrating an example of a process of membership registration and download of the mobile terminal program 41 according to the present example embodiment.

First, the customer uses the mobile terminal 5 to access the web server 4 via the communication company network 9 and causes the mobile terminal 5 to display the membership registration site 40 (step S11). The customer may input personal information in a membership registration form, download the mobile terminal program 41, or the like in the membership registration site 40.

The customer inputs predetermined personal information such as the name, the date of birth, the address, the telephone number, or the like in the membership registration form of the membership registration site 40 (step S12). The mobile terminal 5 transmits the personal information and the terminal ID to the web server 4 (step S13), and the web server 4 receives the personal information and the terminal ID (step S14). Note that the terminal ID is stored in advance in a nonvolatile memory or the like of the mobile terminal 5, for example. The web server 4 issues a membership ID of the customer whose personal information is received (step S15) and transmits the membership ID, the terminal ID, and the personal information to the shop server 2 (step S16).

The shop server 2 registers the received membership ID, terminal ID, and personal information in the membership table of the database 201 in association with each other (step S17). The shop server 2 transmits a registration completion notification to the web server (step S18), and the web server 4 receives the registration completion notification (step S19).

The web server 4 generates a membership code that can be read by the code reader 121 and stores the membership code in association with the membership ID (step S20). Note that the membership code includes information such as a membership ID. The web server 4 transmits the membership ID, the membership code, and the mobile terminal program 41 to the mobile terminal 5 (step S21).

The mobile terminal 5 stores the received membership ID, membership code, and mobile terminal program 41 in the nonvolatile memory of the mobile terminal 5 or the like, for example (step S22). Accordingly, the customer may cause the mobile terminal 5 to start up the mobile terminal program 41 and display the membership ID and the membership code.

Note that, when a customer who has been registered as a membership downloads the mobile terminal program 41 to a new mobile terminal 5, a new terminal ID is registered in the membership table of the database 201 in association with the membership ID of the customer. That is, a plurality of terminal IDs may be present for one membership ID.

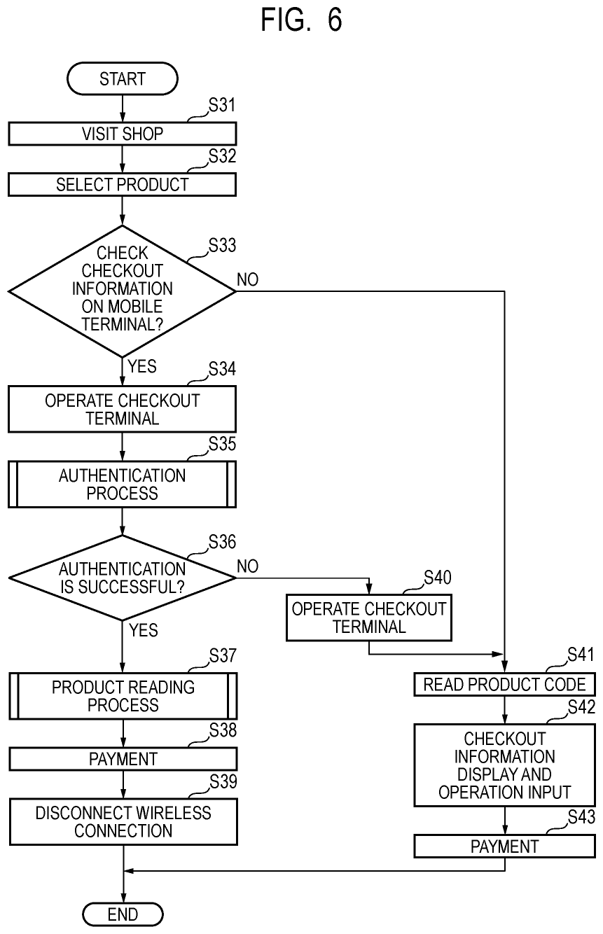

FIG. 6 is a flowchart illustrating an example of a process using the mobile terminal 5 according to the present example embodiment.

First, a customer visits the shop 12 (step S31), selects a product to purchase in the shop 12, and moves to the register area 14 (step S32). The customer chooses whether or not to see checkout information on the mobile terminal 5 (step S33). For example, the customer may cause the mobile terminal 5 to start up the mobile terminal program 41 and display, in a menu window, a message to the effect that he/she wants to see checkout information using the mobile terminal 5 and may present the message to a salesclerk. Further, the customer may orally convey to the salesclerk that he/she wants to see checkout information using the mobile terminal 5. If the customer chooses to see checkout information using the mobile terminal 5 (step S33, YES), the salesclerk performs a predetermined operation on the checkout terminal 11 and enables a setting according to which the customer uses the mobile terminal 5 to perform information display and operation input related to a checkout process (step S34).

The salesclerk uses the POS apparatus 1 to perform an authentication process (step S35). In the authentication process, the POS apparatus 1 reads a membership code displayed on the mobile terminal 5 by using the code reader 121 and acquires the membership ID. In response to the authentication of the membership ID, the POS apparatus 1 starts wireless communication with the mobile terminal 5, receives the terminal ID from the mobile terminal 5, and performs authentication of the terminal ID.

The salesclerk sees whether or not the authentication is successful based on a message displayed on the checkout terminal 11 (step S36). If the authentication is successful (step S36, YES), the salesclerk uses the POS apparatus 1 to perform a product reading process (step S37). In the product reading process, the POS apparatus 1 reads the product code by using the code reader 121 and transmits product information associated with the acquired product ID to the mobile terminal 5. The mobile terminal 5 displays the checkout information on the product and accepts operation input from the customer. Accordingly, the customer may use the mobile terminal 5, instead of the customer terminal 10, to perform information display and operation input related to the checkout process.

The customer makes payment on the checkout terminal 11 based on the total amount of products displayed on the mobile terminal 5 (step S38). In response to completion of the checkout process, the POS apparatus 1 disconnects the wireless connection with the mobile terminal 5 (step S39).

If the authentication is unsuccessful (step S36, NO), the salesclerk performs a predetermined operation on the checkout terminal 11 to cancel the setting enabled in step S34 (step S40) and proceeds to step S41.

If the customer does not choose to see checkout information using the mobile terminal 5 (step S33, NO), the salesclerk causes the code reader 121 to read a code attached to the product to be purchased by the customer (step S41). The checkout information is displayed on the customer terminal 10, and the customer performs operation input on the customer terminal 10 if necessary (step S42). The customer makes payment on the checkout terminal 11 based on the total amount of the products displayed on the customer terminal 10 (step S43).

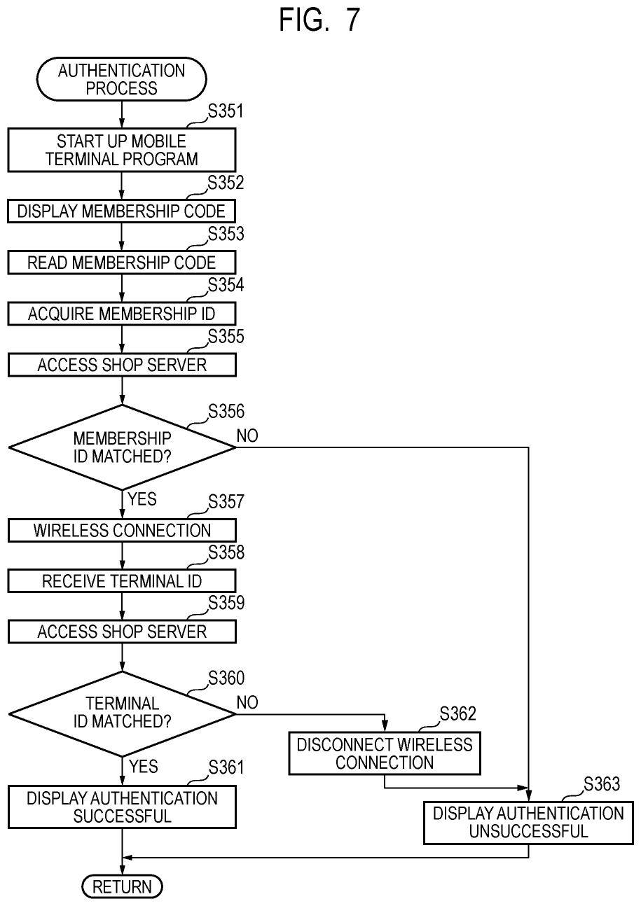

FIG. 7 is a flowchart illustrating an example of the authentication process according to the present example embodiment.

First, the customer causes the mobile terminal 5 to start up the mobile terminal program 41 (step S351) and presents the membership code to the salesclerk by displaying the membership code (step S352). The salesclerk causes the code reader 121 to read the membership code displayed on the mobile terminal 5 (step S353).

The POS apparatus 1 decodes a digital signal output from the code reader 121 by using a decoder and acquires a membership ID included in the membership code (step S354). For example, the POS apparatus 1 accesses the shop server 2 via the wireless communication unit 110 or the wired communication unit 111 (step S355) and determines whether or not the acquired membership ID matches the membership ID stored in the membership table of the database 201 (step S356). If it is determined that these IDs are not matched (step S356, NO), the process proceeds to step S363. On the other hand, if it is determined that these IDs are matched (step S356, YES), the POS apparatus 1 wirelessly connects to the mobile terminal 5 via the wireless communication unit 110 (step S357) and receives the terminal ID from the mobile terminal 5 (step S358).

The POS apparatus 1 accesses the shop server 2 (step S359) and determines whether or not the received terminal ID matches the terminal ID stored in the membership table of the database 201 in association with the membership ID (step S360). If it is determined that these IDs are matched (step S360, YES), an authentication-successful message is displayed on the mobile terminal 5 and the checkout terminal 11 (step S361). On the other hand, if it is determined that these IDs are not matched (step S360, NO), the POS apparatus 1 disconnects the wireless connection with the mobile terminal 5 (step S362), and an authentication-failed message is displayed on the customer terminal 10 and the checkout terminal 11 (step S363).

Note that, if the authentication is successful, the checkout information is displayed on the mobile terminal 5 instead of the customer terminal 10 until the salesclerk performs an operation of forced termination on the checkout terminal 11. The customer may easily see checkout information displayed on the mobile terminal 5 by performing an operation such as pinch-in, pinch-out, or the like, for example. Meanwhile, advertisement information related to a product or the like is displayed on the customer terminal 10, for example. Further, when a product which requires operation input related to the age or the like is included in the products to be purchased by the customer, for example, the customer may perform operation input on the familiar mobile terminal 5 instead of the customer terminal 10.

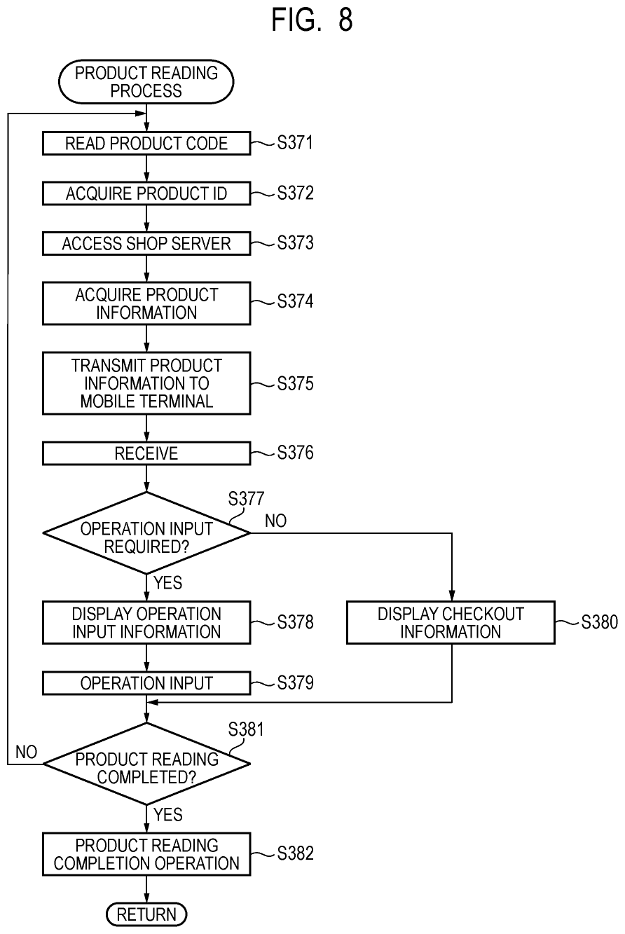

FIG. 8 is a flowchart illustrating an example of the product reading process according to the present example embodiment.

First, the salesclerk causes the code reader 121 to read a code attached to a product to be purchased by the customer (step S371). The POS apparatus 1 decodes a digital signal output from the code reader 121 by using a decoder and acquires a product ID included in the produce code (step S372). For example, the POS apparatus accesses the shop server 2 via the wireless communication unit 110 or the wired communication unit 111 (step S373) and acquires the product information from the product table of the database 201 based on the product ID (step S374). The POS apparatus 1 transmits the product information to the mobile terminal 5 (step S375).

The mobile terminal 5 receives the product information (step S376) and determines whether or not the product requires operation input (step S377). For example, if the operation input flag of the product is “1” and it is thus determined that operation input is required (step S377, YES), the mobile terminal 5 displays the information related to operation input as illustrated on the center screen of FIG. 4 (step S378). The customer performs operation input related to the age or the like, for example, on the mobile terminal 5 (step S379), and the process proceeds to step S381. On the other hand, for example, if the operation input flag of the product is “0” and it is thus determined that no operation input is required (step S377, NO), the mobile terminal 5 displays the checkout information as illustrated on the left screen of FIG. 4 (step S380).

If the salesclerk completes the reading of the produce code (step S381, YES), the salesclerk performs a product reading completion operation on the checkout terminal 11 (step S382). On the other hand, if the salesclerk has not yet completed the reading of the product code (step S381, NO), the process returns to step S371.

As described above, in the present example embodiment, information display and operation input related to a checkout process are performed using a customer's familiar mobile terminal 5, and accordingly, the burden on a customer can be reduced.

### Second Example Embodiment

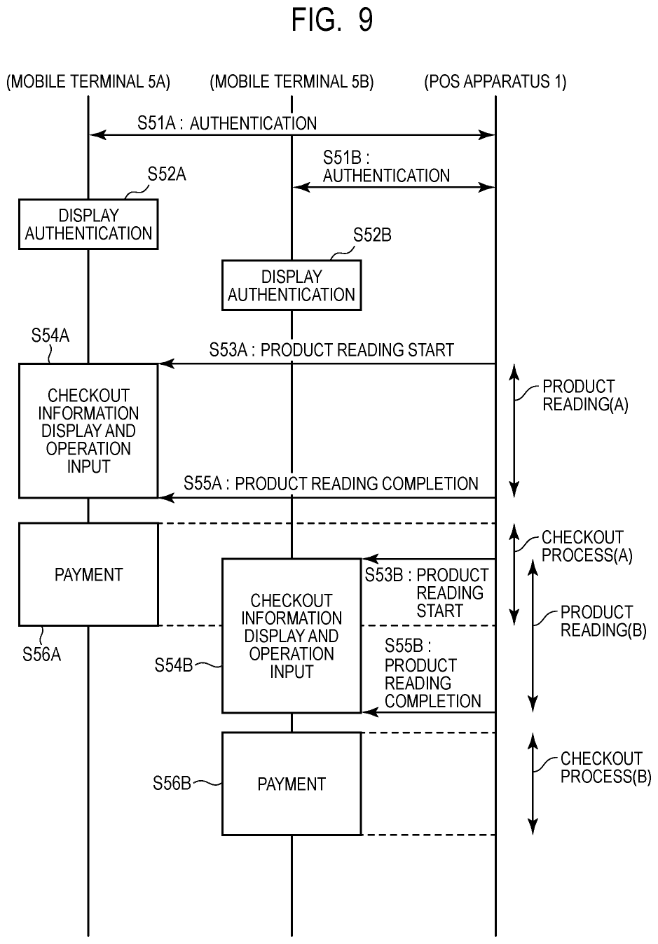

A second example embodiment of the present invention will be described with reference to FIG. 9. The same components as those in the first example embodiment are labeled with the same references, and the description thereof will be omitted or simplified.

In the present example embodiment, a case where information display and operation input related to a checkout process are performed on a plurality of mobile terminals 5 by a single POS apparatus 1 and checkout processes corresponding to respective mobile terminal 5 are performed sequentially will be described.

FIG. 9 is a time chart illustrating an example of a process using a plurality of mobile terminals 5 according to the second example embodiment. In FIG. 9, a case where a first customer and a second customer wait in a line for checkout processes is assumed, for example. The first customer possesses a mobile terminal 5A, and the second customer possesses a mobile terminal 5B.

First, the salesclerk causes the code reader 121 to sequentially read the membership code of the first customer displayed on the mobile terminal 5A and the membership code of the second customer displayed on the mobile terminal 5B (step S51A, step S51B). Note that the salesclerk may cause the code reader 121 to read the membership code of the second customer after completion of reading of the product to be purchased by the first customer. In response to success of the authentication, a message to ask to wait until start of reading of the product or the like is displayed on the mobile terminal 5A and the mobile terminal 5B together with the authentication-successful message, for example (step S52A, step S52B).

The salesclerk starts reading of the code attached to the product to be purchased by the first customer (step S53A). Every time a product code is read, checkout information is displayed on the mobile terminal 5A, and the first customer performs operation input related to the checkout process using the mobile terminal 5A if necessary (step S54A). In response to completion of reading of the product to be purchased by the first customer, the salesclerk performs a product reading completion operation using the checkout terminal 11 (step S55A). The first customer makes payment by using the checkout terminal 11 based on the total amount of the products displayed on the mobile terminal 5A (step S56A).

While the salesclerk is performing the checkout process for the first customer, this salesclerk or another salesclerk starts reading of the code attached to the product to be purchased by the second customer (step S53B). Every time a product code is read, checkout information is displayed on the mobile terminal 5B, and the second customer performs operation input related to the checkout process using the mobile terminal 5B if necessary (step S54B). In response to completion of reading of the product to be purchased by the second customer, the salesclerk performs a product reading completion operation using the checkout terminal 11 (step S55B). The second customer makes payment by using the checkout terminal 11 based on the total amount of the products displayed on the mobile terminal 5B (step S56B).

As described above, in the present example embodiment, information display and operation input related to a checkout process for a plurality of customers are performed on the plurality of mobile terminals 5 instead of the customer terminal 10. Accordingly, it is possible to perform information display and operation input for a plurality of customers without providing a plurality of customer terminals 10.

Further, in the present example embodiment, information display and operation input are performed using the plurality of mobile terminal 5, and accordingly, the waiting time for checkout processes for a plurality of customers can be reduced. Furthermore, also in the present example embodiment, information display and operation input are performed using the customer's familiar mobile terminal, and accordingly, the burden on a customer can be reduced.

### Third Example Embodiment

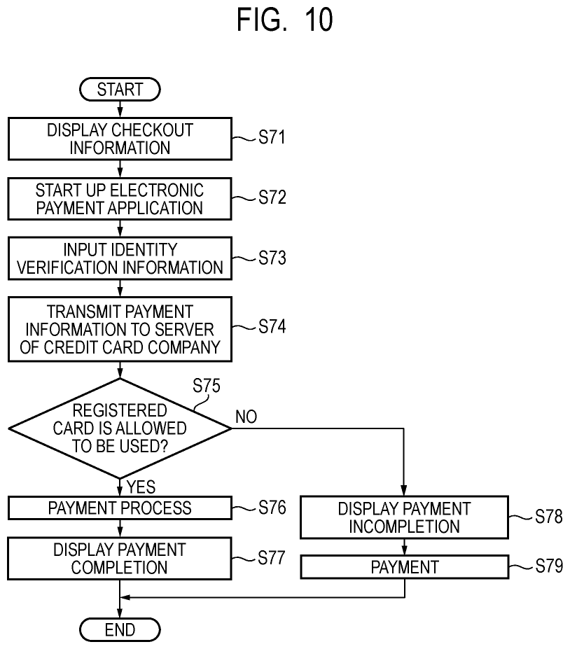

A third example embodiment of the present invention will be described with reference to FIG. 10. The same components as those in the first example embodiment and the second example embodiment are labeled with the same references, and the description thereof will be omitted or simplified.

In the present example embodiment, a case where electronic payment is performed using the mobile terminal 5 based on checkout information displayed on the mobile terminal 5 by using an electronic payment application installed in the mobile terminal 5 will be described.

FIG. 10 is a flowchart illustrating an example of an electronic payment process using the mobile terminal 5 according to the third example embodiment. In FIG. 10, a case where an electronic payment application that can be used in cooperation with the mobile terminal program 41 has already been installed in the mobile terminal 5 and customer's credit card information has been registered is assumed, for example. The electronic payment using the mobile terminal 5 may be, for example, payment based on credit card information, payment by electronic money, or the like. For example, the credit card information is registered in the application described above. Information on the electronic money card is pre-registered in the mobile terminal 5, and thereby the electronic money may be used.

First, a customer causes the mobile terminal 5 to start up the mobile terminal program 41, completes an authentication process and a product reading process, and causes the mobile terminal 5 to display the total amount of purchasing products (step S71). The customer causes the mobile terminal 5 to start up the electronic payment application that has already been installed in and display the payment amount in the electronic payment application (step S72).

The customer inputs identity verification information required for performing electronic payment using the mobile terminal 5 in an electronic application window by fingerprint input, security code input, 3D secure password input, or the like, for example (step S73). The mobile terminal 5 transmits payment information including the payment amount, the identity verification information, or the like to a server of a credit card company (step S74).

The server of the credit card company determines whether or not a registered credit card of the customer is allowed to be used based on the received payment information (step S75). If it is determined that the credit card is allowed to be used (step S75, YES), the server of the credit card company performs a payment process (step S76). The payment process may be, for example, issuance of a billing statement of the customer, credit debit from a specified account of the customer, deposit to a specified account of the shop 12, or the like. The server of the credit card company transmits a payment completion notification to the POS apparatus 1 and the mobile terminal 5, and a payment completion message is displayed on the POS apparatus 1 and the mobile terminal 5 (step S77).

If it is determined that the credit card is not allowed to be used (step S75, NO), the server of the credit card company transmits a payment incompletion notification to the POS apparatus 1 and the mobile terminal 5, and a payment incompletion message is displayed on the POS apparatus 1 and the mobile terminal (step S78). For example, it is determined that the credit card is not allowed to be used when identity verification is unsuccessful, the valid date for the credit card expired, the maximum usage amount is exceeded, or the like. The customer makes payment using the checkout terminal 11 based on the total amount of the products displayed on the mobile terminal 5 (step S79).

As described above, in the present example embodiment, a customer can easily make payment by performing electronic payment by using the mobile terminal 5. Further, also in the present example embodiment, information display and operation input related to a checkout process are performed by using the customer's familiar mobile terminal, and accordingly, the burden on a customer can be reduced.

### Fourth Example Embodiment

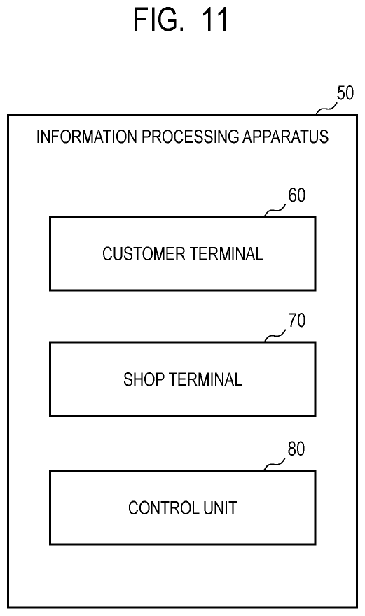

A fourth example embodiment of the present invention will be described with reference to FIG. 11.

FIG. 11 is a general configuration diagram of an information processing apparatus 50 according to the present example embodiment. The information processing apparatus 50 has a shop terminal 70 that performs a checkout process of a product, a customer terminal 60 that performs information display and operation input that are related to the checkout process, and a control unit 80 that causes a mobile terminal possessed by a customer to perform the information display and the operation input related to the checkout process. According to such a configuration, the customer can cause a mobile terminal possessed by the customer to perform information display and operation input related to a checkout process.

As described above, in the present example embodiment, information display and operation input related to a checkout process are performed using the customer's familiar mobile terminal 5, and accordingly, the burden on a customer can be reduced.

### Other Example Embodiments

The present invention is not limited to the example embodiments described above, and modifications are possible as appropriate within the scope not departing from the spirit of the present invention.

Although the case where advertisement information related to a product or the like is displayed on the customer terminal 10 has been described in the above example embodiments, information displayed on the customer terminal 10 is not particularly limited. For example, recommendation information based on a purchase history for a customer, a message to give an advance notice of display of checkout information on the mobile terminal 5, or the like may be displayed. Further, if authentication is successful, a text-to-speech function of the POS apparatus 1 may be stopped, and a message to disable reading aloud of checkout information may be displayed on the checkout terminal 11 to the salesclerk, for example.

Further, although the case where a target to be purchased by a customer is a product has been described in the above example embodiment, the purchased target is not particularly limited. The purchased target may be a service provided in the shop 12, for example.

Further, the scope of each of the example embodiments further includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the computer program described above is stored but also the computer program itself.

The whole or part of the example embodiments disclosed above can be described as, but not limited to, the following supplementary notes.

### (Supplementary Note 1)

An information processing apparatus comprising:

a shop terminal that performs a checkout process of a product or a service;

a customer terminal that performs information display and operation input that are related to the checkout process; and

a control unit that causes a mobile terminal possessed by a customer to perform the information display and the operation input.

### (Supplementary Note 2)

The information processing apparatus according to supplementary note 1, wherein the control unit causes the mobile terminal to perform the information display and the operation input in response to acquiring identification information associated with the mobile terminal.

### (Supplementary Note 3)

The information processing apparatus according to supplementary note 1 or 2, wherein when a predetermined operation is performed on the shop terminal, the control unit causes the mobile terminal to perform the information display and the operation input.

### (Supplementary Note 4)

The information processing apparatus according to any one of supplementary notes 1 to 3, wherein the control unit causes electronic payment in the checkout process to be performed on the mobile terminal.

### (Supplementary Note 5)

The information processing apparatus according to any one of supplementary notes 1 to 4, wherein when the control unit causes to perform the information display and the operation input on the mobile terminal, the control unit does not perform the information display and the operation input on the customer terminal.

### (Supplementary Note 6)

The information processing apparatus according to any one of supplementary notes 1 to 5, wherein when the control unit causes to perform the information display and the operation input on the mobile terminal, the control unit causes the customer terminal to display advertisement information.

### (Supplementary Note 7)

The information processing apparatus according to any one of supplementary notes 1 to 6, wherein the control unit causes a plurality of mobile terminal to perform the information display and the operation input, and the shop terminal sequentially performs the checkout process corresponding to each of the plurality of mobile terminals.

### (Supplementary Note 8)

An information processing method in an information processing apparatus including a shop terminal that performs a checkout process of a product or a service and a customer terminal that performs information display and operation input that are related to the checkout process, the information processing method comprising a step of:

causing a mobile terminal possessed by a customer to perform the information display and the operation input.

### (Supplementary Note 9)

A storage medium storing a program that causes a computer to perform an information processing method in an information processing apparatus including a shop terminal that performs a checkout process of a product or a service and a customer terminal that performs information display and operation input that are related to the checkout process, the program comprising a step of:

causing a mobile terminal possessed by a customer to perform the information display and the operation input.

### (Supplementary Note 10)

A storage medium storing a mobile terminal program executed by a computer of a mobile terminal possessed by a customer, the mobile terminal program comprising a step of:

based on a signal from an information processing apparatus including a shop terminal that performs a checkout process of a product or a service and a customer terminal that performs information display and operation input that are related to the checkout process, causing the mobile terminal to perform the information display and the operation input.

This application is based upon and claims the benefit of priority from Japanese Patent Application No. 2018-051331, filed on Mar. 19, 2018, the disclosure of which is incorporated herein in its entirety by reference.

What is claimed is:

1. An information processing apparatus comprising:
a shop terminal that performs a checkout process of a product or a service;
a customer terminal that performs information display and operation input that are related to the checkout process; and
a control unit that causes a mobile terminal possessed by a customer to perform the information display and the operation input.

2. The information processing apparatus according to claim 1, wherein the control unit causes the mobile terminal to perform the information display and the operation input in response to acquiring identification information associated with the mobile terminal.

3. The information processing apparatus according to claim 1, wherein when a predetermined operation is performed on the shop terminal, the control unit causes the mobile terminal to perform the information display and the operation input.

4. The information processing apparatus according to claim 1, wherein the control unit causes electronic payment in the checkout process to be performed on the mobile terminal.

5. The information processing apparatus according to claim 1, wherein when the control unit causes to perform the information display and the operation input on the mobile terminal, the control unit does not perform the information display and the operation input on the customer terminal.

6. The information processing apparatus according to claim 1, wherein when the control unit causes to perform the information display and the operation input on the mobile terminal, the control unit causes the customer terminal to display advertisement information.

7. The information processing apparatus according to claim 1, wherein the control unit causes a plurality of mobile terminal to perform the information display and the operation input, and the shop terminal sequentially performs the checkout process corresponding to each of the plurality of mobile terminals.

8. An information processing method in an information processing apparatus including a shop terminal that performs a checkout process of a product or a service and a customer terminal that performs information display and operation input that are related to the checkout process, the information processing method comprising:
causing a mobile terminal possessed by a customer to perform the information display and the operation input.

9. A non-transitory storage medium storing a program that causes a computer to perform an information processing method in an information processing apparatus including a shop terminal that performs a checkout process of a product or a service and a customer terminal that performs information display and operation input that are related to the checkout process, the program comprising:
causing a mobile terminal possessed by a customer to perform the information display and the operation input.

10. (canceled)
